(19) United States
(12) Patent Application Publication
(10) Pub. No.: US 2015/0204137 A1
(43) Pub. Date: Jul. 23, 2015

(54) CONTROL AND MOVEMENT DEVICE FOR MOSQUITO SCREENS, CURTAINS AND THE LIKE

(71) Applicant: Paolo Montanaro, Casamassima (IT)

(72) Inventor: Paolo Montanaro, Casamassima (IT)

(73) Assignee: MV LINE S.P.A., Acquaviva Delle Fonti (IT)

(21) Appl. No.: 14/420,869

(22) PCT Filed: Aug. 10, 2012
(86) PCT No.: PCT/IT2012/000256

§ 371 Date: Feb. 10, 2015

(51) Int. Cl. E06B 9/52; E06B 9/56

(52) U.S. Cl. CPC E06B 9/52; E06B 9/56

(57) ABSTRACT

A control and movement device for mosquito screens, curtains, comprising a frame for supporting a sheet, the frame comprising a fixed box, coupled to an edge of the sheet and a movable box fixed on the side opposite to the sheet and performs a translational motion along lower guiding elements and upper guiding elements. The lower guiding elements comprise a link track and have a first end coupled to the base of the box and a second end which slides into an inner seat of the lower headpiece of the movable box. The upper guiding elements comprise a flexible tape having a first end coupled to the top of the fixed box and a second end which slides into an inner seat of the lower headpiece of the movable box and is coupled to the second end of the link track downstream of transmission elements accommodated inside the movable box.

The present invention relates to a control and movement device for mosquito screens, curtains and the like.

As is known, one of the contrivances most often adopted for protecting dwellings and other buildings from bothersome insects such as mosquitoes, flies, shield (or “stink”) bugs etc., consists in arranging sheets constituted by fine mesh nets, or continuous cloths of thin fabric, to cover windows and doors, in order to prevent the entry into the dwelling of such insects, even if the respective window or door is open.

More precisely, according to a widespread implementation solution, such nets and cloths have a perimetric frame comprising a first rigid upright at a side thereof, which is intended to be fixed to a jamb of the window frame, and a second rigid upright, at the opposite side.

The second upright is movable so as to allow the unwinding of the net from a first configuration, in which it is completely gathered at the first upright, to a second configuration, in which the net (the cloth) is completely extended to cover the installation opening, so as to allow the mosquito screen to perform its function as a screen against insects.

The mosquito screen is moreover associated with two flexible link tracks, which form, above and below, a guide for the movement of the second upright, preventing its flexion and/or deviation from the optimal path. Each one of such link tracks is thus constituted by a plurality of segments which are aligned and mutually articulated, and which form, with the side facing the net, a seat which is typically U-shaped for slideably accommodating the respective end portion of the second upright.

In this manner, when the second upright performs a translational motion to bring the mosquito screen from the first configuration to the second configuration, the respective end portions slide in the corresponding seats of the link tracks, which at the same time are strung out along the base and the top of the opening delimited by the window (where they are accommodated in fixed profiles which hide them from view).

However, when the second upright performs a translational motion in the opposite direction, gathering the net at the first upright, each link track is progressively inserted in a respective bezel which is fixed to the second upright.

The aim of this solution is not to have to install fixed guides on the installation threshold which could cause the user to trip over them when passing through the opening.

The use of guiding elements that are constituted by link tracks is a source of considerable costs, which are difficult to contain within the retail price of the mosquito screen.

Moreover, it must be pointed out that the choice to adopt link tracks of the type described above imposes considerable encumbrances which force the producers into complex solutions in order to obtain a correct sizing of the various interconnected elements that go to make up the mosquito screen.

The use is known of elastic laminae (generally made of metallic material) as a substitute for the upper link track guide, to keep costs down and reduce the overall encumbrances (in particular of the actuation bar, which is known as the “bar handle”).

For ensuring that the overall operation of the mosquito screen is efficient, adapted cables are used for the connection of the free end tip of the lamina with the free end tip of the link track.

This connection is aimed at ensuring a simultaneousness of the movements and a balancing thereof during the movement of the “bar handle”.

Naturally the connection cables must be conveniently diverted for the correct connection: for this reason the “bar handle” must also accommodate a plurality of adapted transmission means (such as pulleys and the like).

During installation it is necessary to arrange the cables and dimension them (establish their length) in order to optimize the operation of the entire device: the correct operation of the device is thus subordinated to an optimal installation and thus to the skills of the installing technician.

Moreover the use of conveniently diverted cables determines frequent maintenance in order to verify the state of wear and the possible substitution thereof.

It must be considered that the presence of diverted cables also determines a poor overall robustness of the entire device which, therefore, must be used with care and avoiding movements that are too abrupt and impulsive.

The aim of the present invention is to solve the above-mentioned drawbacks, by providing a control and movement device for mosquito screens, curtains and the like that does not require frequent maintenance.

Within this aim, an object of the invention is to provide a control and movement device for mosquito screens, curtains and the like which is simple and safe to produce, assemble and install.

Another object of the invention is to provide a control and movement device for mosquito screens, curtains and the like which is robust and efficient.

Another object of the invention is to provide a control and movement device for mosquito screens, curtains and the like which is low-cost.

Another object of the present invention is to provide a control and movement device for mosquito screens, curtains and the like which is easily and practically implemented and safe in application.

This aim and these objects are achieved by a control and movement device for mosquito screens, curtains and the like, which are of the roller type, which comprises a frame for supporting a sheet that can be installed at an opening in an element of the type of a wall and the like, said frame comprising a fixed box, which is coupled to an edge of said sheet and is associated stably with a corresponding margin of the opening, and a movable box, which at least partially contains said device and is fixed on the side opposite to said sheet and is able to perform a translational motion along respective lower guiding means and upper guiding means on command, along a direction which is substantially perpendicular to said fixed box, for the transition from a first configuration, in which said sheet is substantially gathered at said fixed box, to a second configuration, in which said sheet is extended to cover said opening, and vice versa, characterized in that said lower guiding means comprise a link track which is constituted by a plurality of mutually articulated segments and has a first end coupled to the base of said fixed box and a second end which can slide into an inner seat of the lower headpiece of said movable box, said upper guiding means comprising a flexible tape having a first end which is coupled to the top of said fixed box and a second end which can slide into an inner seat of the lower headpiece of said movable box and is rigidly coupled to said slideable second end of said link track downstream of adapted transmission means which are inside said movable box.

Further characteristics and advantages of the invention will become better apparent from the description of a preferred, but not exclusive, embodiment of the control and movement device for mosquito screens, curtains and the like according to the invention, which is illustrated by way of non-limiting example in the accompanying drawings wherein:

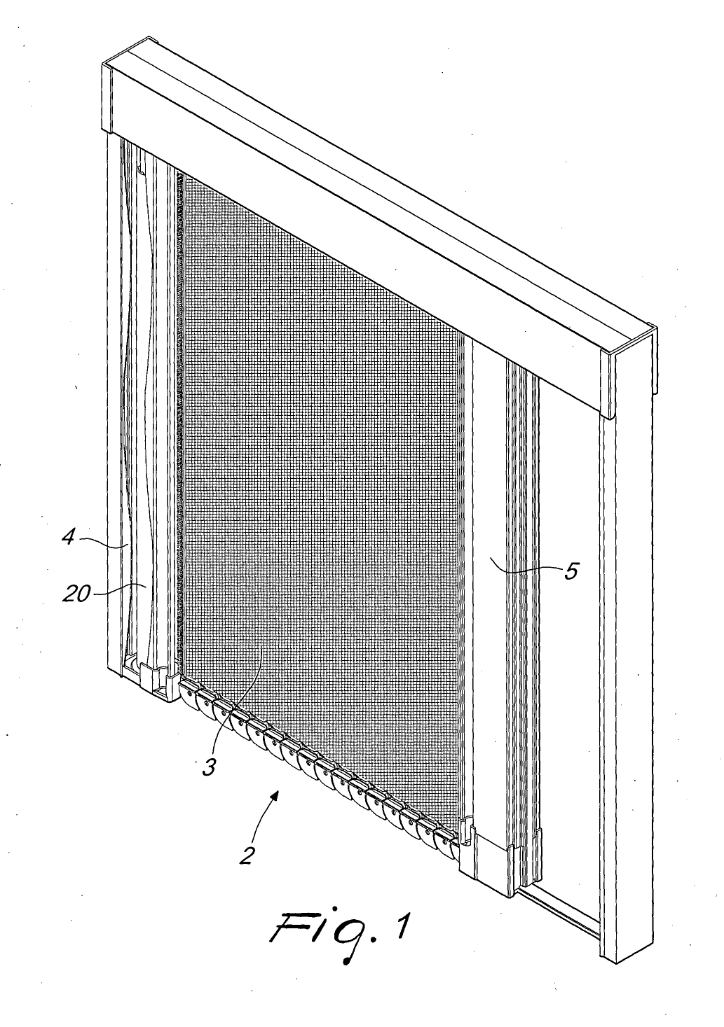

FIG. 1 is a schematic perspective view of a device of the type of a mosquito screen, curtain and the like which is provided with a control and movement device according to the invention;

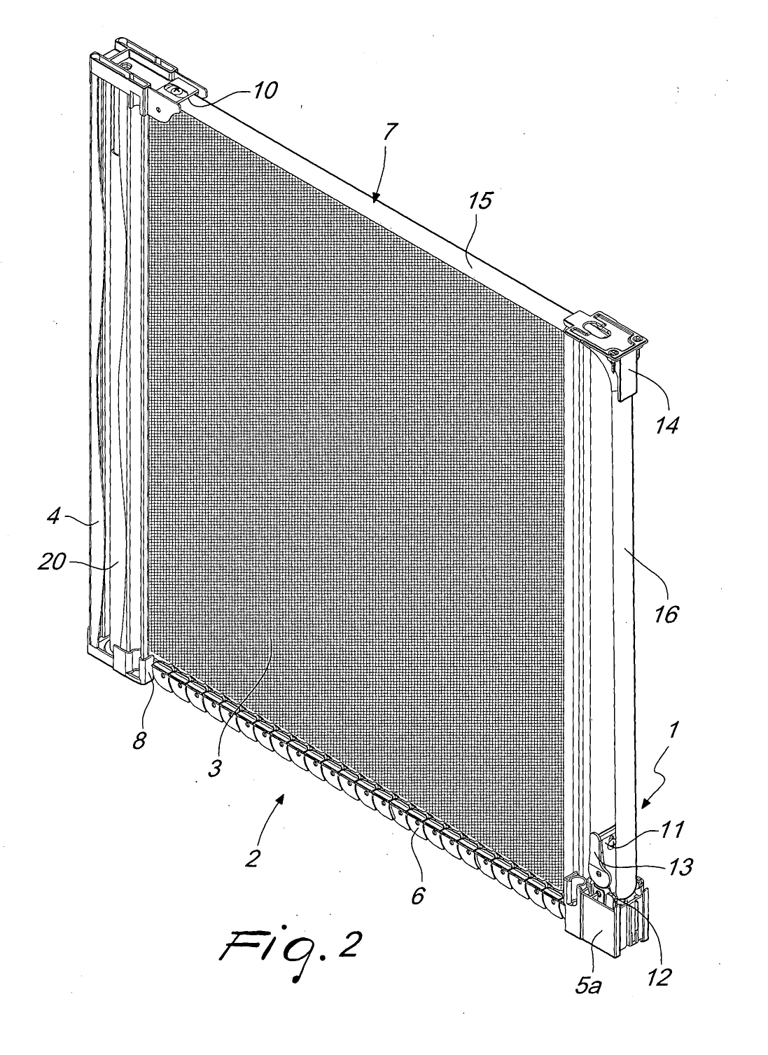

FIG. 2 is a partially sectional schematic perspective view of the device in FIG. 1;

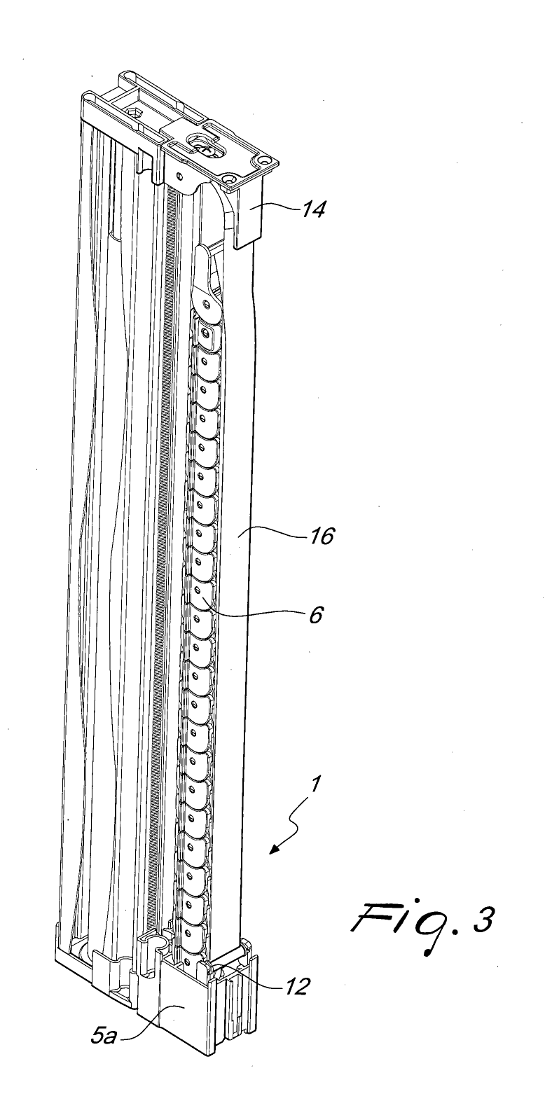

FIG. 3 is a schematic perspective view of a portion of a control and movement device according to the invention;

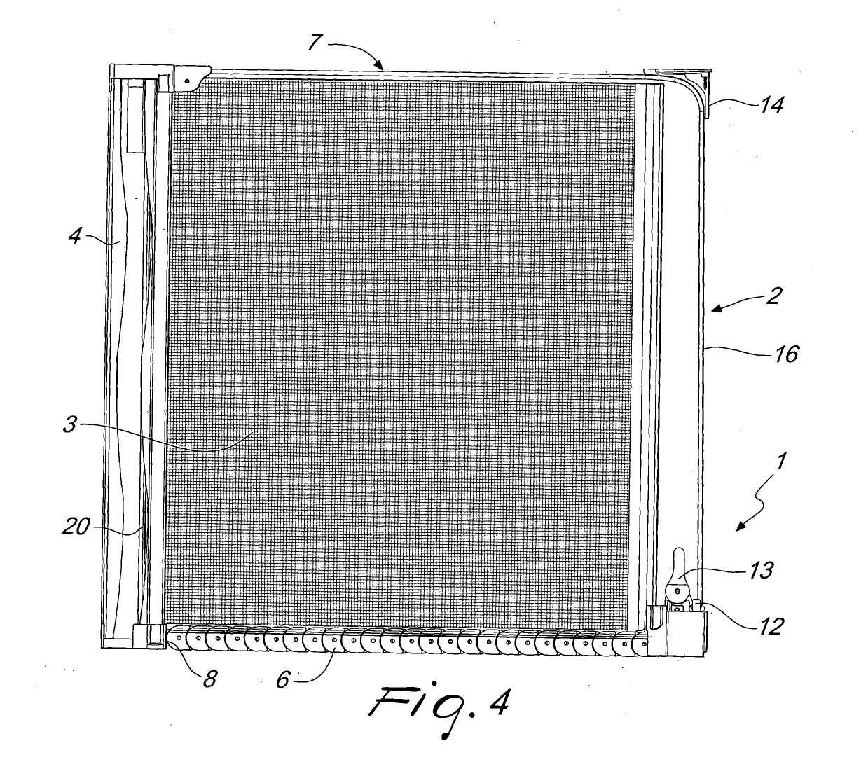

FIG. 4 is a partially sectional side view of a device of the type of a mosquito screen, curtain and the like which is provided with a control and movement device according to the invention;

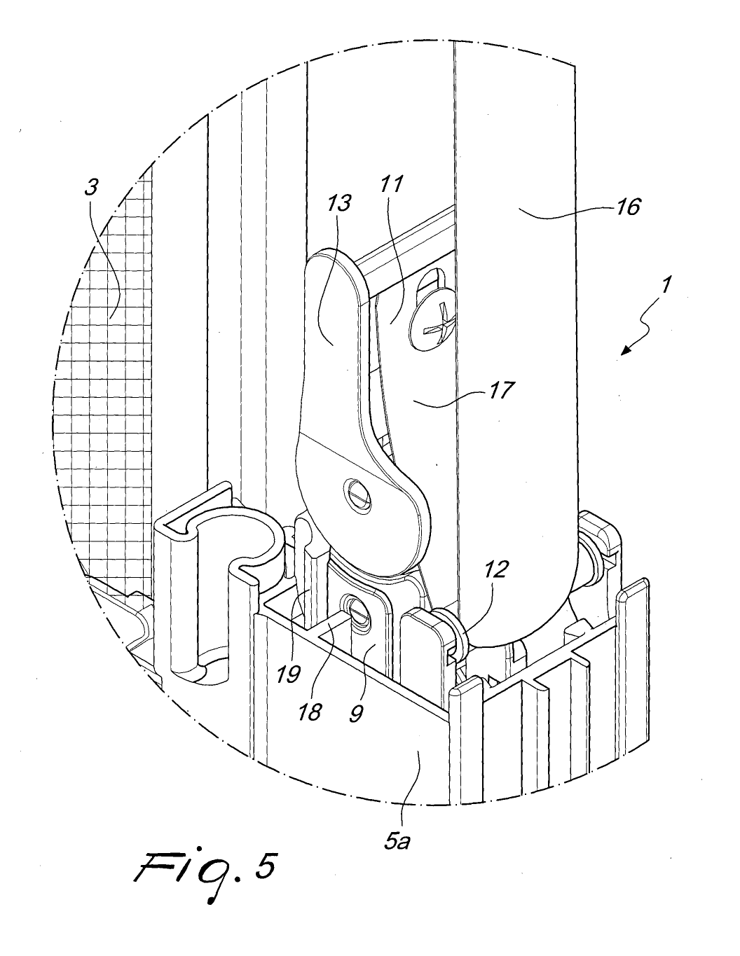

FIG. 5 is a perspective view of a detail of FIG. 3.

With particular reference to the figures, the reference numeral 1 generally designates a control and movement device for mosquito screens 2, curtains and the like which are of the roller type according to the invention.

The mosquito screens 2 that are adaptable to the adoption of a control and movement device 1 according to the invention comprise a supporting frame for a sheet 3 which can be installed at an opening in an element of the type of a wall and the like.

The installation openings can be doors, windows, skylights and other, similar architectural elements of buildings, prefabricated constructions, vehicles, means for transport in general and the like.

The frame comprises in turn a fixed box 4, which is coupled to an edge of the sheet 3 and associated stably with a corresponding margin of the opening, and a movable box 5, which at least partially contains the device 1, which is fixed on the side opposite to the sheet 3.

The movable box 5 comprises a central profiled portion which is coupled to two end headpieces: an upper headpiece and a lower headpiece 5a.

The movable box 5 is able to perform a translational motion along respective lower guiding means 6 and upper guiding means 7, on command, along a direction which is substantially perpendicular to the fixed box 4, for the transition from a first configuration, in which the sheet 3 is substantially gathered at the fixed box 4, to a second configuration, in which the sheet 3 is extended to cover the installation opening, and vice versa.

According to the specific embodiment of the device 1 according to the invention, the lower guiding means 6 comprise a link track 6 which is constituted by a plurality of mutually articulated segments.

The link track 6 can effectively be constituted by pieces made of metallic, polymeric, composite material and the like: each piece will be articulated to the adjoining pieces by means of a respective pin, peg or other, similar element of the type of a hinge.

The link track 6 preferably has a first end 8 coupled to the base of the fixed box 4 and a second end 9 which can slide into an inner seat of the movable box 5 (inner seat of the lower headpiece 5a).

The upper guiding means 7 comprise a flexible tape 7 which has a first end 10 coupled to the top of the fixed box 4 and a second end 11 which can slide into an inner seat of the movable box 5 (inner seat of the lower headpiece 5a).

Such second end 11 is rigidly coupled to the slideable second end 9 of the link track 6 downstream of adapted transmission means 12 inside the lower headpiece 5a of the movable box 5.

According to a specific embodiment of undoubted applicative interest, the end part of the second end 9 of the link track 6 comprises an elongated projection 13, in the direction of the axis of the link track 6 in that area, for the stable accommodation of the second end 11 of the flexible tape 7 on a lateral surface thereof.

The coupling of the end 11 of the flexible tape 7 to the lateral surface of the elongated projection 13 is obtainable, for example, by using a screw, or other threaded means, or peg and the like, which passes through a through hole of the end 11 and engages in a corresponding cavity of the projection 13. If the through hole of the end 11 is slot-shaped (i.e. elongated and/or contoured) then it will be possible to couple the end 11 according to a plurality of different configurations.

It should be noted that the second box 5 can preferably comprise, proximate to its lower headpiece 5a and in the inner seat, an idle roller 12 for the deviation of the flexible tape 7.

According to an embodiment of undoubted effectiveness and certain practical interest, the device 1 can comprise an upper deviator 14 for the orientation of the tape 7 from a first direction which is parallel to the top of the installation opening to a second direction which is parallel to the longitudinal axis of the second box 5 and at right angles to the first direction.

The upper deviator 14 will, in such case, comprise means of adjustment of the position of the slideable accommodation surface of the tape 7 for the tensioning of the tape 7.

For example the adoption of a slot with which to render the rail, which is provided by the surface on which the tape 7 slides, integral with the main body of the flow diverter 14 makes it possible to couple them mutually according to a plurality of different configurations thus making it possible to subject the lamina 7 to a different mechanical tension (by also modifying the position along which it is subjected to the 90° deviation from the first direction to the second direction, defined previously).

It should be noted that, advantageously, the flexible tape 7 comprises a first portion 15, which is proximate to the first end 10 and facing and proximate to the top of the installation opening, a second portion 16 which is facing and proximate to the end face of the second box 5, delimited between the upper deviator 14 and the lower transmission roller 12, and a third portion 17 which is interposed between the second portion 16 and the link track 6 inside the seat of the lower headpiece 5a of the second box 5.

The lengths of the first portion 15 and of the third portion 17 are complementary: in the configuration for covering the installation opening, the length of the first portion 15 will be maximum and the length of the third portion 17 will be minimum; whereas in the completely gathered configuration the length of the first portion 15 will be minimum and the length of the third portion 17 will be maximum. Between these two extreme configurations it will be possible to identify a multiplicity of intermediate configurations in which the lengths of the two lines 15 and 17 will assume intermediate values between those defined previously.

The lower headpiece 5a of the second box 5 preferably comprises a lower through cavity, which is arranged proximate to its base and aligned with the point of attachment of the first end 8 of the link track 6 to the fixed box 4, for the slideable accommodation of the link track 6.

In practice the link track 6 gains access to the inner seat of the lower headpiece 5a of the movable box 5 by sliding through the lower through cavity: such link track 6 will be completely accommodated inside the inner seat of the lower headpiece 5a when the movable box 5 is placed in substantial contact with the first box 4 (when it is facing and proximate to it, resting against it; a configuration that corresponds to the gathered configuration of the sheet 3); the link track 6 will on the other hand be completely resting on the threshold of the installation opening when the movable box 5 is placed in contact with the end wall of the installation opening (when it is facing it and proximate to it, resting against it; a configuration that corresponds to the covering of the installation opening by the sheet 3).

The movable box 5 will comprise, moreover, an upper passage, which is arranged proximate to its top (upper headpiece) and aligned with the point of attachment of the first end 10 of the flexible tape 7 to the fixed box 4, for the slideable accommodation of the flexible tape 7.

In practice the tape 7 gains access to the inner seat of the lower headpiece 5a of the movable box 5 by sliding through the upper passage: such tape 7 will be completely accommodated inside the inner seat of the lower headpiece 5a of the movable box 5 (the first portion 15 will have minimum length) when it is placed in substantial contact with the first box 4 (when it is facing it and proximate to it, resting against it; a configuration that corresponds to the gathered configuration of the sheet 3); the tape 7 will on the other hand be completely resting against the upper surface of the installation opening when the movable box 5 is placed in contact with the end wall of the installation opening (when it is facing it and proximate to it, resting against it; a configuration that corresponds to the covering of the installation opening by the sheet 3).

The inner seat of the lower headpiece 5a of the movable box 5 has a shaped section which is provided with adapted guide ribbing 18 for corresponding lateral complementarily-shaped profiles 19 of the link track 6.

The link track 6 will thus be able to perform a translational motion in the inner seat of the lower headpiece 5a of the movable box 5 along the direction defined by the ribbing 18 (which guides its complementarily-shaped profiles 19), during the movement of the second box 5.

The first box 4 comprises a rotatable roller 20, which is arranged along the longitudinal axis of the first box 4 inside it, for the attachment of the leading edge of the sheet 3 and the winding for gathering of the sheet 3.

Elastic means (for example a twist-action spring arranged inside the roller 20) are preferably interposed between the rotatable roller 20 and the first box 4, for the elastic forcing of the rotation of the roller 20 in a preset direction, generally corresponding to the winding, for gathering, of the sheet 3 on the roller 20.

It should be noted that the sheet 3 is preferably constituted by a fine mesh net which is made preferably of polymeric material, of metallic material, of natural textile fiber and the like.

The possibility is not excluded of using a sheet 3 made of a normal continuous meshed fabric (or a continuous polymeric film) for the purpose of obtaining separation baffles between different environments, instead of mosquito screens.

The flexible tape 7 is preferably made of metallic material, of polymeric material, of composite material and the like.

Conveniently, the present invention thus solves the above problems, by exhaustively defining a control and movement device 1 for mosquito screens, curtains and the like which does not require frequent maintenance.

In fact the adoption of very solid components that are less subject to wear, abrasion and mechanical debilitation, such as the link track 6 and the lamina 7, which are mutually connected without the interposition of other, more delicate elements, gives the assembly 1 according to the invention an optimal robustness that ensures a considerable reduction of maintenance interventions.

Advantageously the control and movement device 1 for mosquito screens, curtains and the like is simple and safe to install.

In fact its assembly is very simple and the installer will not have to arrange and dimension interposed elements between link track 6 and tape 7: the assembly will thus be simpler and its quality will not greatly depend on the skills of the installing technician (the operations of arrangement and dimensioning of the interposed elements, which are envisaged in conventional devices, not being required).

Conveniently the control and movement device 1 for mosquito screens, curtains and the like will thus be particularly robust and efficient: the link track 6 and the lamina 7 will in fact ensure its safe and stable operation in any configuration in which the movable box 5 is located.

Positively the control and movement device 1 for mosquito screens, curtains and the like will be low-cost in that it can be produced by adopting a substantially smaller number of components (as similar as possible) than those of conventional devices, while at the same time it can be easily and quickly installed (thus reducing the cost of labor).

It is thus considered evident that the control and movement device 1 for mosquito screens, curtains and the like will be characterized by a safe and practical application.

The invention, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

Where the technical features mentioned in any claim are followed by reference numerals and/or signs, those reference numerals and/or signs have been included for the sole purpose of increasing the intelligibility of the claims and accordingly, such reference numerals and/or signs do not have any limiting effect on the interpretation of each element identified by way of example by such reference numerals and/or signs.

1-10. (canceled)

11. A control and movement device for mosquito screens, curtains and the like, which are movable and of the roller type, which comprises a frame for supporting a sheet that can be installed at an opening in an element of the type of a wall and the like, said frame comprising a fixed box, which is coupled to an edge of said sheet and is associated stably with a corresponding margin of the opening, and a movable box, which at least partially contains said device and is fixed on a side opposite to said sheet and is able to perform a translational motion along respective lower guiding means and upper guiding means on command, along a direction which is substantially perpendicular to said fixed box, for the transition from a first configuration, in which said sheet is substantially gathered at said fixed box, to a second configuration, in which said sheet is extended to cover said opening, and vice versa, wherein said lower guiding means comprise a link track which is constituted by a plurality of mutually articulated segments and has a first end coupled to a base of said fixed box and a second end which can slide into an inner seat of a lower headpiece of said movable box, said upper guiding means comprising a flexible tape having a first end which is coupled to a top of said fixed box and a second end which can slide into an inner seat of the lower headpiece of said movable box and is rigidly coupled to said slideable second end of said link track downstream of transmission means which are inside said movable box.

12. The device according to claim 11, wherein an end part of said second end of said link track comprises an elongated projection, in a direction of the axis of the link track in that area, for a stable accommodation of said second end of said flexible tape on a lateral surface thereof.

13. The device according to claim 11, wherein said movable box comprises, proximate to a lower end face thereof and to said inner seat of the lower headpiece, an idle roller for deviation of said flexible tape.

14. The device according to claim 13, further comprising an upper deviator for the orientation of the tape from a first direction which is parallel to a top of the opening to a second direction which is parallel to a longitudinal axis of said movable box and at right angles to said first direction, said upper deviator comprising means of adjusting a position of the slideable accommodation surface of said tape for the tensioning of said tape.

15. The device according to claim 13, wherein said flexible tape comprises a first portion, which is proximate to said first end and facing and proximate to the top of said installation opening, a second portion which is facing and proximate to the end face of said movable box, delimited between said upper deviator and said idle roller, and a third portion which is interposed between said second portion and said link track inside said seat of the lower headpiece of said movable box, the lengths of said first portion and of said third portion being complementary, in the configuration of covering said opening the length of said first portion being maximum and the length of said third portion being minimum and in a completely gathered configuration a length of said first portion being minimum and a length of said third portion being maximum.

16. The device according to claim 11, wherein said movable box comprises a lower through cavity, which is arranged proximate to the lower headpiece thereof and aligned with the point of attachment of the first end of said link track to said fixed box, for the slideable accommodation of said link track, and an upper passage, which is arranged proximate to the top thereof and aligned with the point of attachment of the first end of said flexible tape to said fixed box, for the slideable accommodation of said flexible tape.

17. The device according to claim 11, wherein said inner seat of the lower headpiece of said movable box has a shaped section which is provided with guide ribbing for corresponding lateral complementarily-shaped profiles of said link track, said link track performing a translational motion within said inner seat along a direction defined by said ribbing, during the movement of said second box.

18. The device according to claim 11, further comprising a rotatable roller, which is arranged along the longitudinal axis of said fixed box inside said fixed box, for the attachment of the leading edge of said sheet and the winding for gathering said sheet between said rotatable roller and said fixed box elastic means being interposed for the elastic forcing of the rotation of said roller in a preset direction, generally corresponding to the winding, for gathering, of said sheet on said roller.

19. The device according to claim 11, wherein said sheet is constituted by a fine mesh net which is made of polymeric material, of metallic material, of natural textile fiber and the like.

20. The device according to claim 11, wherein said flexible tape is made of metallic material, of polymeric material, of composite material and the like.
